(19) United States
(12) Patent Application Publication
(10) Pub. No.: US 2026/0222865 A1
(43) Pub. Date: Jul. 30, 2026

(54) COMMUNICATION METHOD AND APPARATUS, AND DEVICE AND STORAGE MEDIUM

(71) Applicant: Beijing Xiaomi Mobile Software Co., Ltd., Beijing (CN)

(72) Inventor: Qin MU, Beijing (CN)

(73) Assignee: Beijing Xiaomi Mobile Software Co., Ltd., Beijing (CN)

(21) Appl. No.: 19/144,145

(22) PCT Filed: Dec. 27, 2022
(86) PCT No.: PCT/CN2022/142442

§ 371 Date: Jun. 27, 2025

(51) Int. Cl. H04W 24/10; H04L 41/16; H04W 8/22

(52) U.S. Cl. CPC H04W 24/10; H04L 41/16; H04W 8/22

(57) ABSTRACT

A communication method includes: acquiring a channel measurement result of a terminal based on terminal characteristics of the terminal, and/or using the channel measurement result to perform processing on an Artificial Intelligence (AI) model.

### CROSS-REFERENCE TO RELATED APPLICATION(S)

The present application is a U.S. National Stage of International Application No. PCT/CN2022/142442 filed on Dec. 27, 2022, the disclosure of which is incorporated herein by reference in its entirety.

### TECHNICAL FIELD

The present disclosure relates to the field of communication technology, and in particular to a communication method, apparatus, device and storage medium.

### BACKGROUND

The widespread application of 5G technology has brought great changes to all aspects of people's lives. According to the vision of the International Telecommunication Union (ITU), 5G will penetrate into all areas of the future society and build a comprehensive information ecosystem with users as the center. 5G technology can support extreme business experiences such as mobile virtual reality. Also, 5G technology can support a large number of IoT devices, meet the stringent requirements of vehicle networking and industrial control, and can provide good user experience in high-speed rail environments. It can be imagined that 5G, as a representative of new infrastructure, will focus on building the future information society.

In recent years, Artificial Intelligence (AI) technology has made continuous breakthroughs in many fields. The continuous development of fields such as intelligent voice and computer vision brings a variety of rich and colorful applications to smart terminals. It is also widely used in many fields such as education, transportation, home, medical care, retail, and security. While bringing convenience to people's lives, it is also promoting industrial upgrading in various industries.

In version (release) 18 of the 3rd Generation Partnership Project (3GPP), a research project on Artificial Intelligence technology in radio air interface was established in the Radio Access Network (RAN) 1.

However, existing terminals may include normal terminals and reduced capability terminals, such as Reduced Capability (RedCap) terminals. For example, RedCap terminals have fewer antennas, making the neasurement value of the measured signal to be weaker. Therefore, how to be compatible with different types of terminals to complete corresponding tasks after introducing AI technology into 5G has become a problem that needs to be solved at present.

### SUMMARY

According to a first aspect of the embodiments of the present disclosure, a communication method is provided, which is performed by a terminal. The method includes: acquiring the channel measurement result of the terminal based on the terminal characteristics of the terminal, and/or using the channel measurement result to perform processing on the Artificial Intelligence (AI) model.

According to a second aspect of the embodiments of the present disclosure, a communication method is provided, which is performed by a network device. The method includes: acquiring the channel measurement result of the terminal based on the terminal characteristics of the terminal, and/or using the channel measurement result to perform processing on the Artificial Intelligence (AI) model.

According to a third aspect of the embodiments of the present disclosure, a communication device is provided, including: a processor; and a memory for storing instructions executable by the processor. The processor is configured to perform the first aspect and any one of the methods in the first aspect.

According to a fourth aspect of the embodiments of the present disclosure, a communication device is provided, including: a processor; and a memory for storing instructions executable by the processor. The processor is configured to perform the second aspect and any one of the methods in the second aspect.

It should be understood that the above general description and the detailed description below are only examples and explanatory, and cannot limit the present disclosure.

### BRIEF DESCRIPTION OF THE DRAWINGS

The drawings herein are incorporated into the specification and constitute a part of the specification, illustrate embodiments consistent with the present disclosure, and are used together with the specification to explain the principles of the present disclosure.

FIG. 1 is a schematic diagram of a wireless communication system according to an example embodiment.

FIG. 2 is a flow chart of a communication method according to an example embodiment.

FIG. 3 is a flow chart of another communication method according to an example embodiment.

FIG. 4 is a flow chart of another communication method according to an example embodiment.

FIG. 5 is a flow chart of another communication method according to an example embodiment.

FIG. 6 is a flow chart of another communication method according to an example embodiment.

FIG. 7 is a flow chart of another communication method according to an example embodiment.

FIG. 8 is a flow chart of another communication method according to an example embodiment.

FIG. 9 is a flow chart of another communication method according to an example embodiment.

FIG. 10 is a flow chart of another communication method according to an example embodiment.

FIG. 11 is a flow chart of another communication method according to an example embodiment.

FIG. 12 is a flow chart of another communication method according to an example embodiment.

FIG. 13 is a schematic diagram of a communication apparatus according to an example embodiment.

FIG. 14 is a schematic diagram of another communication apparatus according to an example embodiment.

FIG. 15 is a schematic diagram of a communication device according to an example embodiment.

FIG. 16 is a schematic diagram of another communication device according to an example embodiment.

### DETAILED DESCRIPTION OF THE EMBODIMENTS

The example embodiments will be described in detail here, and instances thereof are shown in the accompanying drawings. When the following description refers to the drawings, unless otherwise indicated, the same numbers in different drawings represent the same or similar elements. The implementations described in the following example embodiments do not represent all the implementations consistent with the present disclosure.

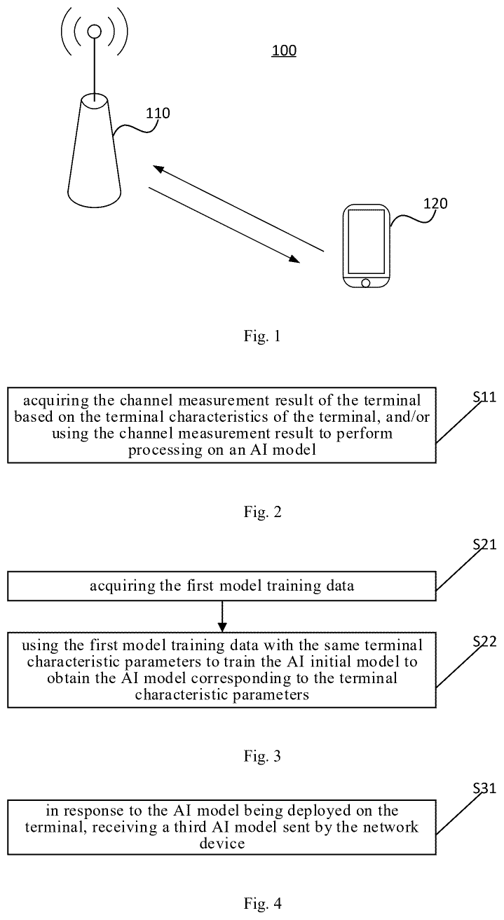

The communication method involved in the present disclosure may be applied to the wireless communication system 100 shown in FIG. 1. The network system may include a network device 110 and a terminal 120. It should be understood that the wireless communication system shown in FIG. 1 is only for schematic illustration. The wireless communication system may also include other network devices, such as core network devices, wireless relay devices, and wireless backhaul devices, which are not shown in FIG. 1. The embodiments of the present disclosure do not limit the number of network devices and the number of terminals included in the wireless communication system.

It should be further understood that the wireless communication system in the embodiments of the present disclosure is a network that provides wireless communication functions. The wireless communication system may adopt different communication technologies, such as Code Division Multiple Access (CDMA), Wideband Code Division Multiple Access (WCDMA), Time Division Multiple Access (TDMA), Frequency Division Multiple Access (FDMA), Orthogonal Frequency-Division Multiple Access (OFDMA), Single Carrier FDMA (SC-FDMA), Carrier Sense Multiple Access with Collision Avoidance. According to the capacity, rate, delay and other factors of different networks, the network may be divided into 2G (2 nd Generation) network, 3G network, 4G network or future evolution network, such as the 5th Generation Wireless Communication System (5G) network. The 5G network may also be called New Radio (NR). For the convenience of description, the present disclosure sometimes refers to the wireless communication network as a network.

Further, the network device 110 involved in the present disclosure may also be called a wireless access network device. The wireless access network device may be: a base station, an evolved Node B (eNB), a home base station, an Access Point (AP) in a Wireless Fidelity (WIFI) system, a wireless relay node, a wireless backhaul node, a Transmission Point (TP) or a Transmission and Receiving Point (TRP), etc. It may also be a gNB in an NR system, or be a component or a part of a base station. When it is a vehicle-to-everything (V2X) communication system, the network device may also be a vehicle-mounted device. It should be understood that in the embodiments of the present disclosure, the specific technology and specific device form adopted by the network device are not limited.

Further, the terminal 120 involved in the present disclosure may also be referred to as a terminal device, a User Equipment (UE), a Mobile Station (MS), a Mobile Terminal (MT), etc., which is a device that provides voice and/or data connectivity to a user. For example, the terminal may be a handheld device with a wireless connection function, a vehicle-mounted device, etc. At present, some examples of terminals are: Mobile Phone, Pocket Personal Computers (PPC), handheld computers, Personal Digital Assistants (PDA), laptops, tablet computers, wearable devices, or vehicle-mounted devices. In addition, when it is a vehicle-to-everything (V2X) communication system, the terminal device may also be a vehicle-mounted device. It should be understood that the embodiments of the present disclosure do not limit the specific technology and specific device form adopted by the terminal.

In the embodiments of the present disclosure, the network device 110 and the terminal 120 may use any feasible wireless communication technology to achieve mutual data transmission. The transmission channel corresponding to the data or control information sent by the network device 110 to the terminal 120 is called a downlink channel (downlink, DL). The transmission channel corresponding to the data or control information sent by the terminal 120 to the network device 110 is called an uplink channel (uplink, UL). It should be understood that the network device involved in the embodiments of the present disclosure may be a base station. It shall be noted that the network device may also be any other possible network device, and the terminal may be any possible terminal, which is not limited by the present disclosure.

The widespread application of 5G technology has brought great changes to all the aspects of people's lives. According to the ITU's vision, 5G will penetrate into all the areas of the future society and build a comprehensive information ecosystem with users as the center. The experience rate for 5G users can reach 100 Mbit/s~1 Gbit/s, which can support extreme service experiences such as mobile virtual reality. The 5G peak rate can reach 10 Gbit/s~20 Gbit/s, and the traffic density can reach 10 Mbit/s/m2, which can support the growth of more than a thousand times of mobile service traffic in the future. The 5G connection density can reach 1 million/m2, which can effectively support a large number of IoT devices. The 5G transmission delay can reach the millisecond level, which can meet the stringent requirements of the Internet of Vehicles and industrial control. 5G can support a mobile speed of 500 km/h, which can meet good user experience in the high-speed rail environment. It can be imagined that 5G, as a representative of new infrastructure, will rebuild the future information society.

In recent years, AI technology has made continuous breakthroughs in many fields. The continuous development of fields such as intelligent voice and computer vision not only brings a variety of rich and colorful applications to terminals, but also has wide applications in education, transportation, home, medical care, retail, security and other fields. While bringing convenience to people's lives, it is also promoting industrial upgrading in various industries. AI technology is also accelerating its cross-penetration with other disciplines. The development of AI technology integrates knowledge from different disciplines and provides new directions and methods for the development of different disciplines.

In the 3GPP Release 18, a research project on Artificial Intelligence technology in radio air interface was established in RAN1. The project aims to study how to introduce Artificial Intelligence technology in radio air interface, and explore how Artificial Intelligence technology can assist in improving the transmission technology of radio air interface.

For example, in the research of wireless AI, the application cases of Artificial Intelligence include:
Channel State Information (CSI) enhancement based on AI
Beam management based on AI
Positioning based on AI.

Existing terminals include many types. For example, there are normal terminals and RedCap terminals. RedCap terminals have fewer receiving antennas than normal terminals. For example, some RedCap terminals have only one receiving (receive, Rx) antenna. Because the number of antennas is reduced compared to normal terminals, at present, RAN4 has some conclusions. That is, for the type of RedCap terminals with 1 Rx, the Reference Signal Receiving Power (RSRP) measurement value will be corrected by 1 dB when applied.

In some application scenarios of AI models, many are based on RSRP. For example, in some AI models used for beam management, the beam information of all beams is predicted based on the measured M RSRPs. For another example, in some AI models used for terminal positioning, the positioning coordinates of the terminal are predicted based on the measured RSRP information.

However, with the same network configuration, the RSRPs measured by normal terminals and RedCap terminals are different. Thus, how to deal with the differences between different terminals in various application scenarios based on AI models, that is, how to be compatible and adapt to different terminals, has become an urgent problem to be solved.

Therefore, the present disclosure proposes to acquire the channel measurement result based on the terminal characteristics of the terminal, and/or perform relevant processing on the AI model. This helps to avoid a situation where the AI model is not compatible with the channel measurement results of different terminals and inaccurate prediction is thereby caused.

FIG. 2 is a flow chart of a communication method according to an example embodiment. As shown in FIG. 2, the method is applied to the terminal and may include the following step S11.

In step S11, acquiring the channel measurement result of the terminal based on the terminal characteristics of the terminal, and/or using the channel measurement result to perform processing on an AI model.

In some embodiments, the terminal may acquire the channel measurement result of its own based on the terminal characteristics of the terminal. Additionally or alternatively, the channel measurement result is used to perform processing on an AI model. For example, the channel measurement result may be RSRP.

In some embodiments, the terminal may determine the terminal characteristics of the terminal itself. In some scenarios, such as when the AI model is deployed on the network device, the terminal determines the terminal characteristics of the terminal itself, which may be determining the characteristics corresponding to the measured RSRP. In other scenarios, such as when the AI model is deployed on the terminal, the terminal determines the terminal characteristics of the terminal itself, which may be determining the AI model corresponding to the terminal. It should be understood that the AI model corresponding to the terminal corresponds to the terminal characteristics of the terminal.

For example, different terminals may have different terminal characteristics. Different terminals may include normal terminals and RedCap terminals. The terminal capability of RedCap terminals is generally lower than that of normal terminals, and has fewer receiving antennas.

For example, the terminal may acquire the RSRP measured by itself. For the RSRP acquired by the terminal, the terminal may send it to the network device. Alternatively, the RSRP acquired by the terminal may be used for subsequent corresponding processing by the terminal, such as inputting it into the AI model. For example, in the scenario where the AI model is deployed on the network device, the terminal may send the acquired RSRP to the network device. For another example, in the scenario where the AI model is deployed on the terminal, after acquiring the RSRP measured by itself, the terminal may input it into the AI model for calculation and prediction, so that the prediction result output by the AI model is obtained. In other words, the terminal may use the AI model and use the RSRP measured by itself for model reasoning.

In some embodiments, performing processing on the AI model may be performing prediction, training, monitoring, etc., on the AI model, which is not limited in the present disclosure.

The present disclosure proposes to acquire the channel measurement result based on the terminal characteristics of the terminal, and/or perform relevant processing on the AI model. This helps to avoid the situation where the AI model is incompatible with the channel measurement results of different terminals and inaccurate prediction is thereby caused.

In the communication method provided by the embodiments of the present disclosure, the terminal includes a first type of terminal and a second type of terminal, and the terminal capability of the first type of terminal is lower than the terminal capability of the second type of terminal.

In some embodiments, the terminal may include a first type of terminal and a second type of terminal. The first type of terminal may be the RedCap terminal mentioned above. The second type of terminal may be the normal terminal mentioned above. Besides, the terminal capability of the first type of terminal is lower than the terminal capability of the second type of terminal.

It should be understood that since the first type of terminal is a RedCap terminal, it has fewer receiving antennas. Therefore, the terminal capability of the RedCap terminal will be lower than the terminal capability of a normal terminal.

The present disclosure may be applied to the case of a normal terminal and a RedCap terminal to determine the terminal characteristics of different terminals, for acquiring the channel measurement result based on the terminal characteristics of the terminal, and/or performing relevant processing on the AI model. This can avoid the situation where the AI model is not compatible with the channel measurement results of different terminals and inaccurate prediction is thereby caused.

In the communication method provided by the embodiments of the present disclosure, the AI model corresponds to a category of terminal characteristics, and the AI model includes a first AI model corresponding to the terminal characteristics of the first type of terminal, and a second AI model corresponding to the terminal characteristics of the second type of terminal.

In some embodiments, each AI model may correspond to a category of terminal characteristics. That is, a category of terminal characteristics corresponds to an AI model. The AI model may include a first AI model corresponding to the terminal characteristics of the first type of terminal. The AI model may also include a second AI model corresponding to the terminal characteristics of the second type of terminal.

In some examples, different AI models may be used for different terminal characteristics, such as different terminal types, different numbers of receiving antennas, different reference signal measurement capabilities, and other terminal characteristics. Therefore, the case may be that the terminal includes a first type of terminal and a second type of terminal. The AI model may include a first AI model corresponding to the terminal characteristics of the first type of terminal. It shall be noted that the AI model may also include a second AI model corresponding to the terminal characteristics of the second type of terminal. It should be understood that if the terminal also includes other types of terminals, the AI model may also include other AI models corresponding to the terminal characteristics of other types of terminals, which is not limited by the present disclosure.

In some embodiments, since each AI model corresponds to the terminal characteristics of a type of terminal, when using the channel measurement result to perform processing on the AI model, it is usually not necessary to process the channel measurement result, but instead input it into the corresponding AI model directly. It shall be noted that in some cases, the channel measurement result acquired by the terminal may also be adaptively adjusted, such as conversion and calculation based on a preset method. This can be set according to the actual situations, and the present disclosure is not limited in this regard.

According to the present disclosure, different terminal characteristics correspond to corresponding AI models respectively, so that the AI model corresponding to the terminal characteristics can be processed using the channel measurement result. This can avoid the situation where the AI model is incompatible with the channel measurement results of different terminals and inaccurate prediction is thereby caused.

In the communication method provided by the embodiments of the present disclosure, the method may also include: in response to the AI model being deployed on the terminal, receiving the AI model corresponding to the terminal characteristics of the terminal and sent by the network device.

In some embodiments, if the AI model is deployed on the terminal, the terminal may receive the AI model corresponding to the terminal characteristics of the terminal and sent by the network device.

For example, when the terminal accesses the network and communicates with the network device, it may first send its own terminal characteristics to the network device. This process may be considered as a reporting process of the terminal characteristics. The terminal may send its own terminal capabilities and/or terminal type (that is, information related to the terminal characteristics) to the network device. If the AI model needs to be deployed on the terminal, the network device may, based on the terminal characteristics reported by the corresponding terminal, send the AI model corresponding to the terminal characteristics of the terminal to the terminal, and deploy it on the terminal.

For another example, when the terminal switches between cells, the terminal does not disconnect from the network device, but the network devices in different cells may not be the same network device. In this case, the terminal will not report the terminal characteristics to the network device of the current cell again. Therefore, the network device of the current cell may also acquire the terminal characteristics of the terminal from other network devices. For example, the network device of the current cell is a base station, and other network devices may be core network devices. Based on the terminal characteristics of the terminal acquired from other network devices, the network device of the current cell may send the AI model corresponding to the terminal characteristics of the terminal to the terminal, and deploy it on the terminal.

The present disclosure may be applied to the situation where the AI model is deployed on the terminal, so that the channel measurement result can be used to perform relevant processing on the AI model corresponding to the terminal characteristics. This can avoid the situation where the AI model is incompatible with the channel measurement results of different terminals and inaccurate prediction is thereby caused.

In the communication method provided by the embodiments of the present disclosure, the method may also include: in response to the AI model being deployed on the network device, sending the channel measurement result to the network device.

In some embodiments, the AI model may also be deployed on the network device. In this case, the terminal may send the channel measurement result measured by itself to the network device. For example, the RSRP is sent. Thus, the network device receives the channel measurement result sent by the terminal, and uses the AI model corresponding to the terminal characteristics of the terminal and deployed on the network device to process the received channel measurement result.

In other words, the network device selects the corresponding AI model for different terminal characteristics, and performs corresponding reasoning and prediction on the channel measurement result measured by the terminal.

The present disclosure may be applied to the situation where the AI model is deployed on the network device, so that the channel measurement result can be used to perform relevant processing on the AI model corresponding to the terminal characteristics. This can avoid the situation where the AI model is incompatible with the channel measurement results of different terminals and inaccurate prediction is thereby caused.

In the communication method provided by the embodiments of the present disclosure, FIG. 3 is another flow chart of a communication method according to an example embodiment. As shown in FIG. 3, the AI model is pre-trained in the following steps S21 and S22.

In step S21, acquiring the first model training data.

In some embodiments, training of the AI model may be implemented on the terminal. First, the first model training data for training the AI model is acquired. The first model training data includes terminal characteristic parameters, and the terminal characteristic parameters are used to describe the terminal characteristics.

For example, during the acquiring stage of the training data, when the data directly used for model training is acquired, each piece of data includes not only the input of the model and the data label, but also the terminal characteristics corresponding to the piece of data, for indicating the piece of data is corresponding to a terminal with which terminal characteristic. The terminal characteristics may be terminal type information, the number of receiving antennas of the terminal, etc. The terminal characteristics may also be the terminal measurement RSRP capability information or other capability information, which is not limited in the present disclosure.

In some embodiments, the first model training data may be the channel measurement data directly acquired by the terminal, or the data that is obtained after the channel measurement data directly acquired by the terminal is converted, calculated, etc. based on a preset method. Specifically, a suitable acquisition method may be selected according to the actual situation, which is not limited in the present disclosure.

It shall be noted that in some embodiments, training of the AI model may also be implemented on the network device. The terminal sends, to the network device, the first model training data acquired for training the AI model. Thus, the network device may train the first AI model and/or the second AI model based on the first model training data. It should be understood that the first model training data sent by the terminal may be the channel measurement data directly acquired by the terminal, or the data that is obtained by converting, calculating, and performing other operations on the channel measurement data directly acquired by the terminal based on a preset method.

In step S22, using the first model training data with the same terminal characteristic parameters to train the AI initial model to obtain the AI model corresponding to the terminal characteristic parameters.

In some embodiments, the terminal may group the first model training data with the same terminal characteristic parameters as a training data group according to the terminal characteristic parameters. Also, the training data group may be used to train the AI initial model to obtain the AI model corresponding to the training data group. It should be understood that the trained AI model corresponds to the terminal characteristic parameters of the training data group. This may be also considered as a corresponding AI model being trained for a terminal characteristic, such as the first AI model and/or the second AI model. The AI initial model is an untrained AI model.

For example, two training data groups are divided according to the terminal characteristic parameters. Training data group 1 corresponds to terminal characteristic 1, and training data group 2 corresponds to terminal characteristic 2. The AI initial model is trained using training data group 1 to obtain AI model 1. The AI initial model is trained using training data group 2 to obtain AI model 2. Then, AI model 1 corresponds to terminal characteristic 1, and AI model 2 corresponds to terminal characteristic 2.

It shall be understood that when training the model, different AI models may be constructed for different terminal characteristics, and the AI initial model is trained using samples corresponding to the terminal characteristics. For example, an AI model may be constructed for a RedCap terminal, and an AI model may be constructed for a non-RedCap terminal (such as a normal terminal). For another example, an AI model may also be constructed for a terminal with only one receiving antenna, and another AI model may be constructed for a terminal with more than one receiving antenna. The present disclosure has no limitation on how many AI models are constructed, and which terminal characteristics each AI model corresponds to.

According to the present disclosure, an AI model is trained separately for each terminal characteristic, so that the channel measurement result can be used to perform relevant processing on the AI model corresponding to the terminal characteristic. This can avoid the situation where the AI model is incompatible with the channel measurement results of different terminals and inaccurate prediction is thereby caused.

In the communication method provided by the embodiments of the present disclosure, the AI model corresponds to a plurality of categories of terminal characteristics, and the AI model includes a third AI model. The third AI model corresponds to the terminal characteristics of the first type of terminal, and the third AI model further corresponds to the terminal characteristics of the second type of terminal.

In some embodiments, the AI model may correspond to a plurality of categories of terminal characteristics. That is, terminal characteristics of different categories may correspond to the same AI model. For example, the AI model may correspond to the terminal characteristics of the first type of terminal, and the AI model may also correspond to the terminal characteristics of the second type of terminal. For example, the AI model may be called the third AI model.

In some examples, the same AI model may be used for different terminal characteristics, such as different terminal types, different numbers of receiving antennas, different reference signal measurement capabilities, and other terminal characteristics. Therefore, the case may be that the terminal includes a first type of terminal and a second type of terminal. The AI model may correspond to the terminal characteristics of the first type of terminal and the terminal characteristics of the second type of terminal at the same time.

According to the present disclosure, different terminal characteristics may correspond to the same AI model, so that the channel measurement result can be used to perform relevant processing on the AI model corresponding to the terminal characteristics. This can avoid the situation where the AI model is not compatible with the channel measurement results of different terminals and inaccurate prediction is thereby caused.

In the communication method provided by the embodiments of the present disclosure, FIG. 4 is another flow chart of the communication method shown according to an example embodiment. As shown in FIG. 4, the method may also include the following step S31.

In step S31, in response to the AI model being deployed on the terminal, receiving a third AI model sent by the network device.

In some embodiments, if the AI model is deployed on the terminal, the terminal may receive the AI model corresponding to the terminal characteristics of the terminal and sent by the network device, i.e., the third AI model. It shall be understood that the third AI model corresponds to both the terminal characteristics of the first type of terminal and the terminal characteristics of the second type of terminal. The terminal may use the channel measurement result to process the third AI model sent by the network device.

The present disclosure may be applicable to the situation where the AI model is deployed on the terminal, so that the channel measurement result is used to perform relevant processing on the AI model corresponding to the terminal characteristics. This can avoid the situation where the AI model is not compatible with the channel measurement results of different terminals and inaccurate prediction is thereby caused.

In the communication method provided by the embodiments of the present disclosure, FIG. 5 is another flow chart of the communication method shown according to an example embodiment. As shown in FIG. 5, using the channel measurement result to perform processing on the Artificial Intelligence (AI) model in S11 may include the following steps S41 and S42.

In step S41, in response to the terminal being the first type of terminal, correcting the channel measurement result.

In some embodiments, in response to the terminal being the first type of terminal, the terminal may correct the acquired channel measurement result. For example, the measured RSRP is corrected for the first time. It shall be noted that the correction of RSRP is not the above-mentioned different operations such as conversion and calculation based on the preset method. It should be understood that the purpose of correcting RSRP is to compensate for the situation where the measured RSRP of the first type of terminal is weak due to hardware reasons.

For example, if the terminal is a RedCap terminal with lower capability, it may be considered that the terminal's ability to measure RSRP is also weak. That is, such a terminal will make certain corrections to the measured RSRP before processing the RSRP, such as the first correction. For example, it may be corrected by adding 1 dB to the RSRP measured by the terminal.

In step S42, using the corrected channel measurement result to perform processing on the AI model.

In some embodiments, the terminal may use the corrected channel measurement result to perform processing on the AI model, such as the corrected RSRP. It should be understood that the AI model on which the processing is performed may be the third AI model. The corrected channel measurement result is input into the third AI model for processing to obtain the corresponding prediction result.

For example, regarding the measurement result of the terminal, the corresponding data correction is first performed before inputting into the third AI model for reasoning. That is, the terminal will make a first correction to the RSRP measured by its own device. Then, the corrected RSRP is used for performing processing on the third AI model. At the same time, regarding the output obtained by the third AI model, if it is also RSRP information, the output of the third AI model also needs to be corrected before application. For example, for a RedCap 1 Rx terminal, the measured RSRP needs to be corrected first and then input into the third AI model. If the output obtained by the third AI model is also RSRP, the output RSRP needs to be corrected for the second time and then applied subsequently.

The second correction may be the reverse correction of the first correction, such as subtracting 1 dB, or may be a pre-set correction, or may be specified in a protocol, which is not limited by the present disclosure.

According to the present disclosure, the channel measurement result measured by some terminals is corrected, and the corrected channel measurement result is used to perform relevant processing on the AI model corresponding to the terminal characteristics. This can avoid the situation where the AI model is not compatible with the channel measurement results of different terminals and inaccurate prediction is thereby caused.

In the communication method provided by the embodiments of the present disclosure, using the channel measurement result to perform processing on the Artificial Intelligence (AI) model in S11 may also include: in response to the terminal being the second type of terminal, using the channel measurement result to perform processing on the AI model.

In some embodiments, in response to the terminal being the second type of terminal, the terminal may directly use the channel measurement result acquired by the terminal to perform processing on the AI model. For example, the terminal directly inputs the acquired channel measurement result into the third AI model for prediction.

For example, the second type of terminal is a normal terminal, or a terminal with normal capabilities.

For some terminals, according to the present disclosure, the channel measurement result may be directly used to perform relevant processing on the AI model corresponding to the terminal characteristics. This can avoid the situation where the AI model is not compatible with the channel measurement results of different terminals and inaccurate prediction is thereby caused.

In the communication method provided by the embodiments of the present disclosure, FIG. 6 is a flow chart of another communication method shown according to an example embodiment. As shown in FIG. 6, in response to the AI model being deployed on the network device, acquiring the channel measurement result of the terminal for processing in S11 may include the following steps S51 and S52.

In step S51, in response to the terminal being the first type of terminal, correcting the channel measurement result.

In some embodiments, in response to the terminal being the first type of terminal, the terminal may correct the acquired channel measurement result, for example, performing a first correction on the measured RSRP.

For example, if the terminal is a RedCap terminal with lower capability, it may be considered that the terminal has a weaker capability to measure RSRP. That is, such a terminal will make certain corrections to the measured RSRP, such as the first correction. For example, the RSRP measured by the terminal may be corrected by adding 1 dB.

In step S52, sending the corrected channel measurement result to the network device.

In some embodiments, the terminal may send the corrected RSRP in S51 to the network device. Thus, the network device receives the corrected RSRP and uses the corrected RSRP to perform corresponding processing on the AI model corresponding to the terminal characteristics of the first type of terminal and the terminal characteristics of the second type of terminal.

In some embodiments, steps S51 and S52 may also be replaced by sending the channel measurement result to the network device in response to the terminal being the first type of terminal.

In some embodiments, the AI model may be deployed on the network device, and the terminal may directly send the acquired channel measurement result to the network device. In the case where the terminal is the first type of terminal, the terminal may also directly send the acquired channel measurement results to the network device. Also, the network device corrects the channel measurement result sent by the first type of terminal, such as by performing the first correction.

The present disclosure may be applied to the case where the AI model is deployed on the network device, so that the channel measurement result is used to perform relevant processing on the AI model corresponding to the terminal characteristics. This can avoid the situation where the AI model is not compatible with the channel measurement results of different terminals and the prediction is thereby inaccurate.

In the communication method provided by the embodiments of the present disclosure, in response to the AI model being deployed on the network device, acquiring the channel measurement result of the terminal for processing in S11 may include: in response to the terminal being the second type of terminal, sending the channel measurement result to the network device.

In some embodiments, the AI model may be deployed on the network device, and the terminal may directly send the acquired channel measurement result to the network device. For the case where the terminal is the second type of terminal, since the second type of terminal is a normal terminal, it may be considered that the channel measurement result acquired by the second type of terminal does not need to be additionally corrected. The terminal may directly send the acquired channel measurement result to the network device. Thus, the network device performs processing on the AI model according to the channel measurement result sent by the second type of terminal.

The present disclosure may be applied to the case where the AI model is deployed on the network device, so that the channel measurement result is used to perform relevant processing on the AI model corresponding to the terminal characteristics. This can avoid the situation where the AI model is not compatible with the channel measurement results of different terminals and the prediction is thereby inaccurate.

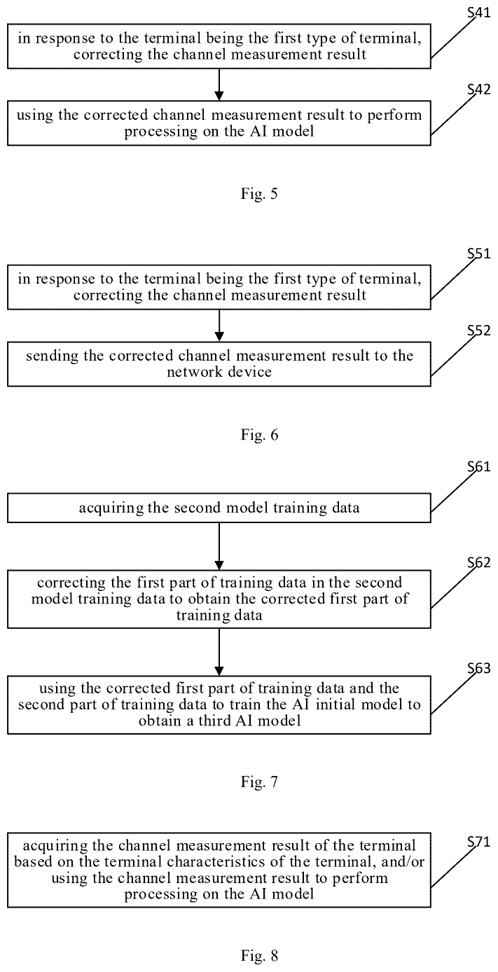

In the communication method provided by the embodiments of the present disclosure, FIG. 7 is another flow chart of a communication method according to an example embodiment. As shown in FIG. 7, the AI model is pre-trained in the following steps S61, S62, and S63.

In step S61, acquiring the second model training data.

In some embodiments, training of the AI model may be implemented on the terminal. First, the second model training data for training the AI model is acquired. The second model training data includes terminal characteristic parameters, and the terminal characteristic parameters are used to describe the terminal characteristics.

For example, during the acquiring stage of the training data, when the data directly used for model training is acquired, each piece of data includes not only the input of the model and the data label, but also the terminal characteristics corresponding to the piece of data, for indicating the piece of data is corresponding to the terminal with which terminal characteristic. The terminal characteristics may be the terminal type information, the number of receiving antennas of the terminal, etc. The terminal characteristics may also be the terminal measurement RSRP capability information or other capability information, which is not limited by the present disclosure.

In some embodiments, the second model training data may be the channel measurement data directly acquired by the terminal, or may be the data that is obtained after the channel measurement data directly acquired by the terminal is converted, calculated, etc. based on a preset method. Specifically, a suitable acquisition method may be selected according to the actual situation, which is not limited by the present disclosure.

It shall be noted that in some embodiments, training of the AI model may also be implemented on the network device. The terminal sends the acquired second model training data for training the AI model to the network device. Thus, the network device may train the third AI model based on the second model training data. It may be understood that the second model training data sent by the terminal may be the channel measurement data directly acquired by the terminal, or may be the data that is obtained by converting, calculating, or performing other operations based on a preset method on the channel measurement data directly acquired by the terminal.

In step S62, the first part of training data in the second model training data is corrected to obtain the corrected first part of training data.

In some embodiments, when training the AI model, the first part of training data in the second model training data may be corrected, such as the first correction. Thus, the corrected first part of training data is obtained. The terminal characteristics described by the terminal characteristic parameters of the first part of training data correspond to the first type of terminal.

It may be understood that since the trained AI model needs to adapt to different terminal characteristics, the training data corresponding to different terminals need to be corrected during training. For example, the second model training data corresponding to the first type of terminal may be called the first part of training data. Also, because the first type of terminal is a RedCap terminal with lower capability, it is necessary to correct the training data corresponding to this type of terminal, for example, by adding 1 dB.

For example, when the terminal acquires and reports the training data, in addition to reporting the second model training data acquired for training, the terminal also reports its terminal characteristics, for example, the terminal type, the number of receiving antennas of the terminal, etc. When the device for training the AI model receives the second model training data of the terminal, it performs different processing on the second model training data according to the terminal characteristics. If it is a RedCap 1 Rx terminal, the corresponding RSRP is corrected, for example, by adding 1 dB.

For another example, when the terminal acquires and reports the training data, the processed data may be reported. For example, for a RedCap 1 Rx terminal, the RSRP collected by the device may be processed and then reported. For example, the acquired RSRP is corrected by adding 1 dB and then used for training the AI model.

In step S63, using the corrected first part of training data and the second part of training data to train the AI initial model to obtain a third AI model.

In some embodiments, the terminal may use the corrected first part of training data and the second part of training data to train the AI initial model together to obtain the third AI model. The terminal characteristics described by the terminal characteristic parameters of the second part of training data correspond to the second type of terminal. The AI initial model is an untrained AI model. It may be understood that the trained third AI model corresponds to the terminal characteristics of the first type of terminal, and also corresponds to the terminal characteristics of the second type of terminal.

It may be understood that in model training, the same AI model may be constructed for different terminal characteristics.

According to the present disclosure, the same AI model may by trained for different terminal characteristics, so that the channel measurement result is used to perform relevant processing on the AI model corresponding to the terminal characteristics. This can avoid the situation where the AI model is not compatible with the channel measurement results of different terminals and inaccurate prediction is thereby caused.

In the communication method provided by the embodiments of the present disclosure, the terminal characteristics include: a terminal type and/or a terminal capability.

In some embodiments, the terminal characteristics may be the terminal type.

For example, it may be a first type of terminal, a second type of terminal, etc. It may be understood that terminals of different terminal types also have different terminal capabilities.

In some embodiments, the terminal characteristics may be the terminal capability.

For example, the terminal capability may be reflected by the number of antennas of the terminal. It shall be noted that the terminal capability may also be reflected by the ability of the terminal to measure RSRP. Alternatively, the terminal capability may also indicate that the terminal has some specific capabilities, such as the transmission power capability, etc., which are not limited by the present disclosure.

The present disclosure provides a variety of terminal characteristics so as to use the channel measurement result to perform relevant operations on the AI model adapted to the terminal characteristics. This can avoid the situation where the AI model is not compatible with the channel measurement results of different terminals and inaccurate prediction is thereby caused.

Based on the same concept, the present disclosure also provides a communication method executed by a network device.

FIG. 8 is a flow chart of another communication method according to an example embodiment. As shown in FIG. 7, the method is applied to a network device and may include the following step S71.

In step S71, acquiring the channel measurement result of the terminal based on the terminal characteristics of the terminal, and/or using the channel measurement result to perform processing on the AI model.

In some embodiments, the network device may collect the channel measurement result of the terminal based on the terminal characteristics of the terminal. Additionally or alternatively, the channel measurement result is used for performing processing on the AI model. For example, the channel measurement result may be RSRP.

In some embodiments, the network device may determine the terminal characteristics of the terminal. In some scenarios, determining the terminal characteristics of the terminal may be determining the characteristics corresponding to the measured RSRP. In other scenarios, determining the terminal characteristics of the terminal may be determining the corresponding AI model. It may be understood that the corresponding AI model corresponds to the terminal characteristics of the terminal.

For example, different terminals may have different terminal characteristics. Different terminals may include normal terminals and RedCap terminals. The terminal capability of the RedCap terminal is generally lower than that of the normal terminal and has fewer receiving antennas.

In the scenario where the AI model is deployed on the terminal, the acquired channel measurement result of the terminal may be used to train the AI model. In the scenario where the AI model is deployed on the network device, acquiring the channel measurement result of the terminal may be obtaining the channel measurement result acquired by the terminal. At the same time, in this scenario, using the channel measurement result to perform processing on the AI model may be using the channel measurement result sent by the terminal to perform processing on the AI model.

For example, the network device may acquire the RSRP measured by the terminal for training the AI model. For another example, the network device may also acquire the RSRP measured by the terminal, and input the acquired RSRP into the AI model for corresponding prediction, so as to obtain the prediction result output by the AI model. In other words, the network device may use the AI model and use the RSRP measured by the terminal for model reasoning.

In some embodiments, the processing performed on the AI model may be AI model prediction, training, monitoring, etc., which is not limited by the present disclosure.

According to the present disclosure, the channel measurement result is acquired based on the terminal characteristics of the terminal, and/or relevant processing is performed on the AI model. This can avoid the situation where the AI model is incompatible with the channel measurement results of different terminals and inaccurate prediction is thereby caused.

In the communication method provided by the embodiments of the present disclosure, the terminal includes a first type of terminal and a second type of terminal, and the terminal capability of the first type of terminal is lower than the terminal capability of the second type of terminal.

In some embodiments, the terminal may include a first type of terminal and a second type of terminal. The first type of terminal may be the RedCap terminal mentioned above. The second type of terminal may be the normal terminal mentioned above. Besides, the terminal capability of the first type of terminal is lower than the terminal capability of the second type of terminal.

It may be understood that since the first type of terminal is a RedCap terminal, it has fewer receiving antennas. Therefore, its terminal capability will be lower than the terminal capability of a normal terminal.

The present disclosure may be applied to the case of a normal terminal and a RedCap terminal to determine the terminal characteristics of different terminals. Thus, the channel measurement result is acquired based on the terminal characteristics of the terminal, and/or relevant processing is performed on the AI model. This can avoid the situation where the AI model is incompatible with the channel measurement results of different terminals and inaccurate prediction is thereby caused.

In the communication method provided by the embodiments of the present disclosure, the AI model corresponds to a category of terminal characteristics, and the AI model includes a first AI model corresponding to the terminal characteristics of the first type of terminal, and a second AI model corresponding to the terminal characteristics of the second type of terminal.

In some embodiments, each AI model may correspond to a category of terminal characteristics. That is, a category of terminal characteristics corresponds to an AI model. The AI model may include a first AI model corresponding to the terminal characteristics of the first type of terminal, and the AI model may also include a second AI model corresponding to the terminal characteristics of the second type of terminal.

In some examples, different AI models may be used for different terminal characteristics, such as different terminal types, different numbers of receiving antennas, different reference signal measurement capabilities, and other terminal characteristics. Therefore, the case may be that the terminal includes a first type of terminal and a second type of terminal. The AI model may include a first AI model corresponding to the terminal characteristics of the first type of terminal. It shall be noted that the AI model may also include a second AI model corresponding to the terminal characteristics of the second type of terminal. It may be understood that if the terminal also includes other types of terminals, the AI model may also include other AI models corresponding to the terminal characteristics of other types of terminals, which is not limited by the present disclosure.

In some embodiments, each AI model corresponds to the terminal characteristics of a type of terminal. Thus, when the channel measurement result is used for processing the AI model, it is usually not necessary to process the channel measurement result, and the the channel measurement result may be input into the corresponding AI model directly. It shall be noted that in some cases, the channel measurement result acquired by the terminal may also be adaptively adjusted, such as by performing conversion and calculation based on a preset method. This may be set according to the actual situation, which is not limited by the present disclosure.

According to the present disclosure, different terminal characteristics may correspond to corresponding AI models respectively, so that the channel measurement result can be used to perform relevant processing on the AI model corresponding to the terminal characteristics. This can avoid the situation where the AI model is incompatible with the channel measurement results of different terminals and inaccurate prediction is thereby caused.

In the communication method provided by the embodiments of the present disclosure, the method may also include: in response to the AI model being deployed on the terminal, sending the AI model corresponding to the terminal characteristics of the terminal to the terminal.

In some embodiments, if the AI model is deployed on the terminal, the network device may send the AI model corresponding to the terminal characteristics of the terminal to the terminal.

For example, when the terminal accesses the network and communicates with the network device, it may first send its own terminal characteristics to the network device. This process may be considered as a reporting process of the terminal characteristics. The terminal may send its own terminal capabilities and/or terminal type (that is, information related to the terminal characteristics) to the network device. If the AI model needs to be deployed on the terminal, according to the terminal characteristics reported by the corresponding terminal, the network device may send the AI model corresponding to the terminal characteristics of the terminal to the terminal, and deploy it on the terminal.

For another example, when the terminal switches between cells, the terminal does not disconnect from the network device, but the network devices of different cells may not be the same network device. In this case, the terminal will not report the terminal characteristics to the network device of the current cell again. Therefore, the network device of the current cell may also obtain the terminal characteristics of the terminal from other network devices. For example, the network device of the current cell is a base station, and other network devices may be core network devices. According to the terminal characteristics of the terminal obtained from other network devices, the network device of the current cell may send the AI model corresponding to the terminal characteristics of the terminal to the terminal, and deploy it on the terminal.

The present disclosure may be applied to the situation where the AI model is deployed on the terminal, so as to use the channel measurement result to perform relevant processing on the AI model corresponding to the terminal characteristics. This can avoid the situation where the AI model is not compatible with the channel measurement results of different terminals and inaccurate prediction is thereby caused.

In the communication method provided by the embodiments of the present disclosure, acquiring the channel measurement result of the terminal in S71 may include: in response to the AI model being deployed on the network device, receiving the channel measurement result sent by the terminal.

In some embodiments, the AI model may also be deployed on the network device. In this case, the network device may receive the channel measurement result measured and sent by the terminal, for example, the RSRP measured by the terminal. In order for the network device to receive the channel measurement result sent by the terminal, the AI model corresponding to the terminal characteristics of the terminal and deployed on the network device may be used to process the received channel measurement result.

In other words, the network device selects the corresponding AI model for different terminal characteristics, and performs corresponding reasoning and prediction on the channel measurement result measured by the terminal.

The present disclosure may be applied to the situation where the AI model is deployed on the network device, so as to use the channel measurement result to perform relevant processing on the AI model corresponding to the terminal characteristics. This can avoid the situation where the AI model is not compatible with the channel measurement results of different terminals and inaccurate prediction is thereby caused.

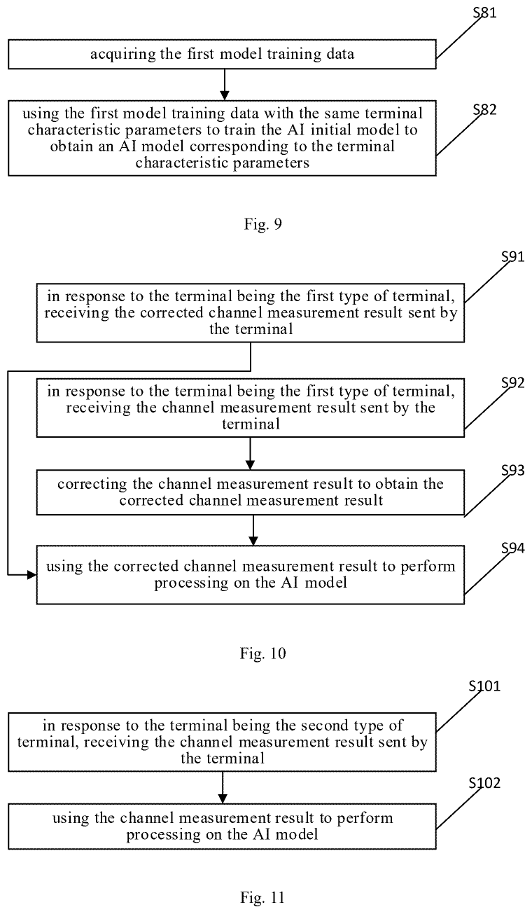

In the communication method provided by the embodiments of the present disclosure, FIG. 9 is a flow chart of another communication method according to an example embodiment. As shown in FIG. 9, acquiring the channel measurement result of the terminal in S71 may include: acquiring the channel measurement result of the terminal used for training. The channel measurement result of the terminal for training includes the first model training data.

In some embodiments, if the AI model is trained on the network device, the network device acquires the channel measurement result of the terminal, which may be acquiring the channel measurement result of the terminal for training. The channel measurement result of the terminal for training includes the first model training data. The network device may receive the first model training data sent by the terminal. Alternatively, the first model training data is received through other devices, or the first model training data is pre-stored, which is not limited by the present disclosure.

In some embodiments, the AI model is pre-trained in the following steps S81 and S82.

In step S81, acquiring the first model training data.

In some embodiments, training of the AI model may be implemented on the network device. First, the first model training data for training the AI model is acquired. The first model training data includes terminal characteristic parameters, and the terminal characteristic parameters are used to describe the terminal characteristics.

For example, during the acquiring stage of the training data, when the data directly used for model training is acquired, each piece of data includes not only the input of the model and the data label, but also the terminal characteristics corresponding to the piece of data, for indicating the piece of data is corresponding to the terminal with which terminal characteristic. The terminal characteristics may be the terminal type information, the number of receiving antennas of the terminal, etc. The terminal characteristics may also be the terminal measurement RSRP capability information or other capability information, which is not limited in the present disclosure.

In some embodiments, the first model training data may be the channel measurement data directly acquired by the terminal and sent to the network device. It may also be the data that is obtained after the channel measurement data directly acquired by the terminal is converted, calculated, etc. based on a preset method, and the corresponding processed data is sent to the network device. Specifically, a suitable acquisition method may be selected according to the actual situation, which is not limited in the present disclosure.

It shall be noted that in some embodiments, training of the AI model may also be implemented on the terminal.

In step S82, using the first model training data with the same terminal characteristic parameters to train the AI initial model to obtain an AI model corresponding to the terminal characteristic parameters.

In some embodiments, the terminal may group the first model training data with the same terminal characteristic parameters as a training data group according to the terminal characteristic parameters. Besides, a training data group is used to train the AI initial model, so that the AI model corresponding to the training data group is obtained. It may be understood that the trained AI model corresponds to the terminal characteristic parameters of the training data group. This may also be considered that a corresponding AI model is trained for a terminal characteristic, such as the first AI model and/or the second AI model. The AI initial model is an untrained AI model.

For example, two training data groups are divided according to the terminal characteristic parameters. Training data group 1 corresponds to terminal characteristic 1, and training data group 2 corresponds to terminal characteristic 2. The AI initial model is trained using training data group 1 to obtain AI model 1, and the AI initial model is trained using training data group 2 to obtain AI model 2. Then, AI model 1 corresponds to terminal characteristic 1, and AI model 2 corresponds to terminal characteristic 2.

It may be understood that during model training, different AI models may be constructed for different terminal characteristics, and the AI initial model may be trained using samples of the corresponding terminal characteristics. For example, an AI model may be constructed for a RedCap terminal, and an AI model may be constructed for a non-RedCap terminal (such as a normal terminal). For another example, an AI model may also be constructed for a terminal with only one receiving antenna, and another AI model may be constructed for a terminal with more than one receiving antenna. The present disclosure neither limits how many AI models are constructed, nor limits which terminal characteristics each AI model corresponds to.

According to the present disclosure, an AI model may be trained separately for each terminal characteristic, so that the AI model corresponding to the terminal characteristic can be processed by using the channel measurement result. This can avoid the situation where the AI model is incompatible with the channel measurement results of different terminals and inaccurate prediction is thereby caused.

In the communication method provided by the embodiments of the present disclosure, the AI model corresponds to a plurality of categories of terminal characteristics, and the AI model includes a third AI model. The third AI model corresponds to the terminal characteristics of the first type of terminal, and the third AI model further corresponds to the terminal characteristics of the second type of terminal.

In some embodiments, the AI model may correspond to a plurality of categories of terminal characteristics. That is, different categories of terminal characteristics may correspond to the same AI model. For example, the AI model may correspond to the terminal characteristics of the first type of terminal, and the AI model may also correspond to the terminal characteristics of the second type of terminal. For example, the AI model may be referred to as a third AI model.

In some examples, the same AI model may be used for different terminal characteristics, such as different terminal types, different numbers of receiving antennas, different reference signal measurement capabilities, and other terminal characteristics. Therefore, the case may be that the terminal includes a first type of terminal and a second type of terminal. The AI model may correspond to the terminal characteristics of the first type of terminal and the terminal characteristics of the second type of terminal at the same time.

The present disclosure may correspond to the same AI model for different terminal characteristics, so as to use the channel measurement result to perform relevant processing on the AI model corresponding to the terminal characteristics. This can avoid the situation where the AI model is incompatible with the channel measurement results of different terminals and inaccurate prediction is thereby caused.

In the communication method provided by the embodiments of the present disclosure, the method may also include: in response to the AI model being deployed on the terminal, sending a third AI model to the terminal.

In some embodiments, if the AI model is deployed on the terminal, the network device may send an AI model corresponding to the terminal characteristics of the terminal, i.e., a third AI model, to the terminal. It may be understood that the third AI model may correspond to both the terminal characteristics of the first type of terminal and the terminal characteristics of the second type of terminal. Thus, the terminal may use the channel measurement result to process the third AI model sent by the network device.

The present disclosure may be applicable to the case where the AI model is deployed on the terminal, so that the channel measurement result is used to perform relevant processing on the AI model corresponding to the terminal characteristics. This can avoid the situation where the AI model is incompatible with the channel measurement results of different terminals and inaccurate prediction is thereby caused.

In the communication method provided by the embodiments of the present disclosure, FIG. 10 is a flow chart of another communication method shown according to an example embodiment. As shown in FIG. 10, in response to the AI model being deployed on the network device, acquiring the channel measurement result of the terminal may include the following step S91.

In some embodiments, in step S91, in response to the terminal being the first type of terminal, receiving the corrected channel measurement result sent by the terminal.

In some embodiments, if the AI model is deployed on the network device, the network device may receive the corrected channel measurement result sent by the terminal, such as the corrected RSRP. Thus, the network device uses the corrected RSRP to perform corresponding operations on the AI model(s) corresponding to the terminal characteristics of the first type of terminal and the terminal characteristics of the second type of terminal.

It shall be noted that in other embodiments, step S91 may also be replaced by the following steps S92 and S93.

In step S92, in response to the terminal being the first type of terminal, receiving the channel measurement result sent by the terminal.

In some embodiments, if the AI model is deployed on the network device, the network device may receive the channel measurement result sent by the terminal, such as the RSRP measured by the terminal. Thus, the network device uses the RSRP to perform corresponding operations on the AI model(s) corresponding to the terminal characteristics of the first type of terminal and the terminal characteristics of the second type of terminal.

In step S93, correcting the channel measurement result to obtain the corrected channel measurement result.

In some embodiments, the network device may correct the received channel measurement result. For example, if the channel measurement result received by the network device is the channel measurement result acquired by the first type of terminal, the received channel measurement result may be corrected for the first time. For example, the RSRP received and acquired by the first type of terminal is corrected for the first time.

For example, if the terminal is a RedCap terminal with lower capability, it may be considered that the terminal's ability to measure RSRP is also weak. That is, such a terminal will make certain corrections to the measured RSRP before processing the RSRP, such as by performing the first correction. For example, the RSRP measured by the terminal may be corrected by adding 1 dB.

It may be understood that the first correction for the channel measurement result acquired by the first type of terminal may be performed at the terminal before being sent to the network device. Alternatively, the terminal may send the uncorrected channel measurement result and correct it at the network device.

Using the channel measurement result to perform processing on the Artificial Intelligence (AI) model in S71 may include the following step S94.

In step S94, using the corrected channel measurement result to perform processing on the AI model.

In some embodiments, the network device may use the corrected channel measurement result, such as the corrected RSRP, to perform processing on the AI model. It may be understood that the AI model on which the processing is performed may be a third AI model. The corrected channel measurement result is input into the third AI model for processing to obtain the corresponding prediction results.

For example, for the received measurement result of the terminal, the corresponding data correction is performed first before being input into the third AI model for reasoning. That is, the network device will perform the first correction on the RSRP measured by the terminal. Then, the corrected RSRP is used for performing processing on the third AI model. At the same time, for the output obtained by the third AI model, if it is also RSRP information, the output of the third AI model also needs to be corrected before application. For example, for the RedCap 1 Rx terminal, the measured RSRP needs to be corrected for the first time and then input into the third AI model. If the output obtained by the third AI model is also RSRP, the output RSRP needs to be corrected for the second time for subsequent application.

The second correction may be the reverse correction of the first correction, such as subtracting 1 dB, or may be a pre-set correction, or may be specified in a protocol, which is not limited by the present disclosure.

According to the present disclosure, the channel measurement result measured by some terminals is corrected, and the corrected channel measurement result is used to perform relevant processing on the AI model corresponding to the terminal characteristics. This can avoid the situation where the AI model is incompatible with the channel measurement results of different terminals and inaccurate prediction is thereby caused.

In the communication method provided by the embodiments of the present disclosure, FIG. 11 is a flow chart of another communication method according to an example embodiment. As shown in FIG. 11, acquiring the channel measurement result of the terminal in response to the AI model deployed on the network device in S71 includes the following step S101.

In step S101, in response to the terminal being the second type of terminal, receiving the channel measurement result sent by the terminal.

In some embodiments, in the scenario where the AI model is deployed on the network device, in response to the terminal being the second type of terminal, the network device may receive the channel measurement result acquired and sent by the terminal.

Using the channel measurement result to perform processing on the Artificial Intelligence (AI) model in S71 may include the following step S102.

In step S102, using the channel measurement result to perform processing on the AI model.

In some embodiments, the network device may use the channel measurement result received in S101 to directly perform processing on the AI model, such as inputting the channel measurement result into the third AI model for prediction.

It may be understood that the second type of terminal is a normal terminal or a normal capability terminal. Therefore, the channel measurement result acquired by the second type of terminal may be directly input into the AI model without additional processing. It shall be noted that in some cases, the channel measurement result may also be adaptively adjusted according to the actual situation, such as by conversion and calculation based on a preset method, etc., which is not limited by the present disclosure.

For some terminals, according to the present disclosure, the channel measurement result may be directly used to perform relevant processing on the AI model corresponding to the terminal characteristics. This can avoid the situation where the AI model is not compatible with the channel measurement results of different terminals and inaccurate prediction is thereby caused.

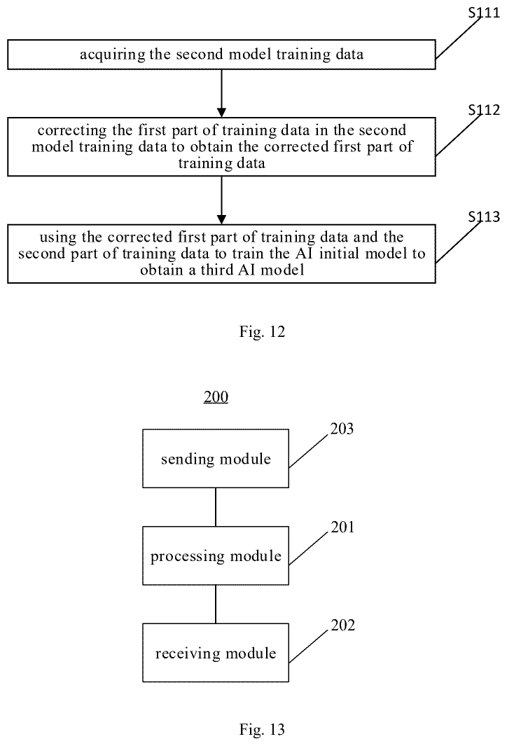

In the communication method provided by the embodiments of the present disclosure, FIG. 12 is a flow chart of another communication method shown according to an example embodiment. As shown in FIG. 12, acquiring the channel measurement result of the terminal in S71 may include: acquiring the channel measurement result of the terminal for training. The channel measurement result of the terminal for training includes the first model training data.

In some embodiments, if the AI model is trained on the network device, the network device acquires the channel measurement result of the terminal, which may be acquiring the channel measurement result of the terminal for training. The channel measurement result of the terminal for training includes the second model training data. The network device may receive the second model training data sent by the terminal. Alternatively, the second model training data is received through other devices, or the second model training data is pre-stored, which is not limited by the present disclosure.

In some embodiments, the AI model is pre-trained in the following steps S111, S112, and S113.

In step S111, acquiring the second model training data.

In some embodiments, training of the AI model may be implemented on the network device. First, the second model training data for training the AI model is acquired. The second model training data includes terminal characteristic parameters, and the terminal characteristic parameters are used to describe the terminal characteristics.

For example, during the acquiring stage of the training data, when the data directly used for model training is acquired, each piece of data includes not only the input of the model and the data label, but also the terminal characteristics corresponding to the piece of data, for indicating the piece of data is corresponding to the terminal with which terminal characteristic. The terminal characteristics may be the terminal type information, the number of receiving antennas of the terminal, etc. The terminal characteristics may also be the terminal measurement RSRP capability information or other capability information, which is not limited by the present disclosure.

In some embodiments, the second model training data may be the channel measurement data directly acquired by the terminal, or the data that is obtained by converting, calculating, etc. the channel measurement data directly acquired by the terminal based on a preset method. Specifically, a suitable acquisition method may be selected according to the actual situation, which is not limited by the present disclosure.

It shall be noted that in some embodiments, training of the AI model may also be implemented on the terminal.

In step S112, correcting the first part of training data in the second model training data to obtain the corrected first part of training data.

In some embodiments, when training the AI model, the first part of training data in the second model training data may be corrected, such as the first correction. Thus, the corrected first part of training data is obtained. The terminal characteristics described by the terminal characteristic parameters of the first part of training data correspond to the first type of terminal.

It may be understood that the trained AI model needs to adapt to different terminal characteristics. Therefore, the training data corresponding to different terminals need to be corrected during training. For example, the second model training data corresponding to the first type of terminal may be called the first part of training data. Besides, since the first type of terminal is a RedCap terminal with lower capabilities, it is necessary to correct the training data corresponding to this type of terminal, such as by increasing 1 dB.

For example, when the terminal acquires and reports the training data, in addition to reporting the second model training data acquired for training, the terminal also reports its terminal characteristics, for example, the terminal type, the number of receiving antennas of the terminal, etc. When the device for training the AI model receives the second model training data of the terminal, it performs different processing on the second model training data according to the terminal characteristics. If it is a RedCap 1 Rx terminal, the corresponding RSRP is corrected, such as by adding 1 dB.

For another example, when the terminal acquires and reports training data, it may report the processed data. For example, for a RedCap 1 Rx terminal, the RSRP acquired by the device may be processed before reporting. For example, the acquired RSRP is corrected by adding 1 dB and then used for training the AI model.

In step S113, using the corrected first part of training data and the second part of training data to train the AI initial model to obtain a third AI model.

In some embodiments, the terminal may use the corrected first part of training data and the second part of training data to train the AI initial model together to obtain the third AI model. The terminal characteristics described by the terminal characteristic parameters of the second part of training data correspond to the second type of terminal, and the AI initial model is an untrained AI model. It may be understood that the trained third AI model corresponds to the terminal characteristics of the first type of terminal, and also corresponds to the terminal characteristics of the second type of terminal.

It may be understood that in model training, the same AI model may be constructed for different terminal characteristics.

According to the present disclosure, the same AI model may be trained for different terminal characteristics, so as to use the channel measurement result to perform relevant processing on the AI model corresponding to the terminal characteristics. This can avoid the situation where the AI model is not compatible with the channel measurement results of different terminals and the prediction is thereby inaccurate.

In the communication method provided by the embodiments of the present disclosure, the terminal characteristics include: the terminal type and/or the terminal capability.

In some embodiments, the terminal characteristics may be the terminal type.

For example, it may be a first type of terminal, a second type of terminal, and the like. It may be understood that terminals of different terminal types also have different terminal capabilities.

In some embodiments, the terminal characteristics may be the terminal capability.

For example, the terminal capability may be reflected by the number of antennas of the terminal. It shall be noted that the terminal capanbility may also be reflected by the ability of the terminal to measure RSRP. Alternatively, the terminal capability may also indicate that the terminal has some specific capabilities, such as the transmission power capability, etc., which are not limited by the present disclosure.

The present disclosure provides a variety of terminal characteristics so as to use the channel measurement result to perform relevant operations on the AI model adapted to the terminal characteristics. This can avoid the situation where the AI model is not compatible with the channel measurement results of different terminals and the prediction is thereby inaccurate.

It should be noted, those skilled in the art may understand that the various implementations/embodiments involved in the above-mentioned embodiments of the present disclosure may be used in conjunction with the aforementioned embodiments or may be used independently. Whether used alone or in conjunction with the aforementioned embodiments, the implementation principles are similar. In the implementations of the present disclosure, some embodiments are described in terms of implementations used together. It shall be noted, those skilled in the art may understand that such examples are not limitations on the embodiments of the present disclosure.

Based on the same concept, the embodiments of the present disclosure also provide a communication apparatus and a communication device.

It may be understood that the communication apparatus and device provided in the embodiments of the present disclosure include hardware structures and/or software modules corresponding to the execution of each function in order to realize the above-mentioned functions. Combined with the units and algorithm steps of the various examples disclosed in the embodiments of the present disclosure, the embodiments of the present disclosure may be implemented in the form of hardware or a combination of hardware and computer software. Whether a function is executed in the form of hardware or computer software driving the hardware depends on the specific application and design constraints of the technical solution. Those skilled in the art may use different methods to implement the described functions for each specific application, but such implementation should not be considered to exceed the scope of the technical solution in the embodiments of the present disclosure.

FIG. 13 is a schematic diagram of a communication apparatus according to an example embodiment. Referring to FIG. 13, the communication apparatus 200 is configured at a terminal, and the communication apparatus 200 includes a processing module 201. The processing module 201 is configured to: acquire the channel measurement result of the terminal based on the terminal characteristics of the terminal, and/or use the channel measurement result to perform processing on the Artificial Intelligence (AI) model.

According to the present disclosure, the channel measurement result is acquired based on the terminal characteristics of the terminal, and/or relevant operations are performed on the AI model. This can avoid the situation where the AI model is not compatible with the channel measurement results of different terminals and inaccurate prediction is caused.

In an embodiment, the terminal includes a first type of terminal and a second type of terminal, and the terminal capability of the first type of terminal is lower than the terminal capability of the second type of terminal.

The present disclosure may be applied to the case of a normal terminal and a RedCap terminal to determine the terminal characteristics of different terminals. Thus, the channel measurement result is acquired based on the terminal characteristics of the terminal, and/or relevant processing is performed on the AI model. This can avoid the situation where the AI model is not compatible with the channel measurement results of different terminals and inaccurate prediction is thereby caused.

In an embodiment, the AI model corresponds to a category of terminal characteristics, and the AI model includes a first AI model corresponding to the terminal characteristics of the first type of terminal, and a second AI model corresponding to the terminal characteristics of the second type of terminal.

According to the present disclosure, different terminal characteristics may correspond to corresponding AI models respectively, so as to use the channel measurement result to perform relevant processing on the AI model corresponding to the terminal characteristics. This can avoid the situation where the AI model is not compatible with the channel measurement results of different terminals, thereby resulting in inaccurate prediction.

In an embodiment, the communication apparatus 200 also includes a receiving module 202. The receiving module 202 is configured to: in response to the AI model being deployed on the terminal, receive the AI model corresponding to the terminal characteristics of the terminal and sent by the network device.

The present disclosure may be applied to the situation where the AI model is deployed on the terminal, so as to use the channel measurement result to perform relevant processing on the AI model corresponding to the terminal characteristics. This can avoid the situation where the AI model is not compatible with the channel measurement results of different terminals, thereby resulting in inaccurate prediction.

In an embodiment, the communication apparatus 200 also includes a sending module 203. The sending module 203 is configured to: in response to the AI model being deployed on the network device, send the channel measurement result to the network device.

The present disclosure may be applied to the situation where the AI model is deployed on the network device, so as to use the channel measurement result to perform relevant processing on the AI model corresponding to the terminal characteristics. This can avoid the situation where the AI model is not compatible with the channel measurement results of different terminals, thereby resulting in inaccurate prediction.

In an embodiment, the AI model is pre-trained by ways of: acquiring the first model training data, where the first model training data includes terminal characteristic parameters, and the terminal characteristic parameters are used to describe the terminal characteristics; using the first model training data with the same terminal characteristic parameters to train the AI initial model to obtain an AI model corresponding to the terminal characteristic parameters, where the AI initial model is an untrained AI model.

According to the present disclosure, an AI model is trained for each terminal characteristic separately, so that the AI model corresponding to the terminal characteristic can be processed by using the channel measurement result. This can avoid the situation where the AI model is not compatible with the channel measurement results of different terminals and the prediction is thereby inaccurate.

In an embodiment, the AI model corresponds to multiple categories of terminal characteristics, and the AI model includes a third AI model. The third AI model corresponds to the terminal characteristics of the first type of terminal, and the third AI model further corresponds to the terminal characteristics of the second type of terminal.

According to the present disclosure, different terminal characteristics may correspond to the same AI model, so that the AI model corresponding to the terminal characteristic can be processed by using the channel measurement result. This can avoid the situation where the AI model is not compatible with the channel measurement results of different terminals and the prediction is thereby inaccurate.

In an embodiment, the receiving module 202 is also configured to: in response to the AI model being deployed on the terminal, receive the third AI model sent by the network device.

The present disclosure may be applicable to the case where the AI model is deployed on the terminal, so as to use the channel measurement result to perform relevant processing on the AI model corresponding to the terminal characteristics. This can avoid the situation where the AI model is not compatible with the channel measurement results of different terminals and the prediction is thereby inaccurate.

In an embodiment, the processing module 201 is also configured to: in response to the terminal being the first type of terminal, correct the channel measurement result; and use the corrected channel measurement result to perform relevant processing on the AI model.

According to the present disclosure, the channel measurement result measured by some terminals may be corrected, and the corrected channel measurement result is used to perform relevant processing on the AI model corresponding to the terminal characteristics. This can avoid the situation where the AI model is not compatible with the channel measurement results of different terminals and the prediction is thereby inaccurate.

In an embodiment, the processing module 201 is also configured to: in response to the terminal being the second type of terminal, use the channel measurement result to perform processing on the AI model.

For some terminals, according to the present disclosure, the channel measurement result may be used directly to perform relevant processing on the AI model corresponding to the terminal characteristics. This can avoid the situation where the AI model is not compatible with the channel measurement results of different terminals and the prediction is thereby inaccurate.

In an embodiment, in response to the AI model being deployed on the network device, the processing module 201 is also configured to: in response to the terminal being the first type of terminal, correct the channel measurement result; the sending module 203 is also configured to send the corrected channel measurement result to the network device. Alternatively, the sending module 203 is also configured to send the channel measurement result to the network device in response to the terminal being the first type of terminal.

The present disclosure may be applied to the case where the AI model is deployed on the network device, so as to use the channel measurement result to perform relevant processing on the AI model corresponding to the terminal characteristics. This can avoid the situation where the AI model is not compatible with the channel measurement results of different terminals and the prediction is thereby inaccurate.

In an embodiment, in response to the AI model being deployed on the network device, the sending module 203 is also configured to: in response to the terminal being the second type of terminal, send the channel measurement result to the network device.

The present disclosure may be applied to the case where the AI model is deployed on the network device, so as to use the channel measurement result to perform relevant processing on the AI model corresponding to the terminal characteristics. This can avoid the situation where the AI model is not compatible with the channel measurement results of different terminals and the prediction is thereby inaccurate.

In an embodiment, the AI model is pre-trained in the following ways: acquiring the second model training data, where the second model training data includes terminal characteristic parameters, and the terminal characteristic parameters are used to describe the terminal characteristics; correcting the first part of training data in the second model training data to obtain the corrected first part of training data, where the terminal characteristics described by the terminal characteristic parameters of the first part of training data correspond to the first type of terminal; using the corrected first part of training data and the second part of training data to train the AI initial model to obtain a third AI model, where the terminal characteristics described by the terminal characteristic parameters of the second part of training data correspond to the second type of terminal, and the AI initial model is an untrained AI model.

According to the present disclosure, the same AI model may be trained for different terminal characteristics, so that the channel measurement result is used to perform relevant processing on the AI model corresponding to the terminal characteristics. This can avoid the situation where the AI model is not compatible with the channel measurement results of different terminals and the prediction is thereby inaccurate.

In an embodiment, the terminal characteristics include: the terminal type and/or the terminal capability.

The present disclosure provides a variety of terminal characteristics, so that the channel measurement result is used to perform relevant operations on the AI model adapted to the terminal characteristics. This can avoid the situation where the AI model is not compatible with the channel measurement results of different terminals and the prediction is thereby inaccurate.

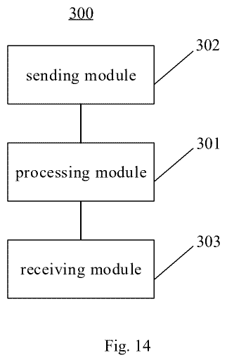

FIG. 14 is a schematic diagram of another communication apparatus according to an example embodiment. Referring to FIG. 14, the communication apparatus 300 is configured at a network device, and the communication apparatus 300 includes a processing module 301. The processing module 301 is configured to: acquire the channel measurement result of the terminal based on the terminal characteristics of the terminal, and/or use the channel measurement result to perform processing on the Artificial Intelligence (AI) model.

According to the present disclosure, the channel measurement result is acquired based on the terminal characteristics of the terminal, and/or relevant processing is performed on the AI model. This can avoid the situation where the AI model is incompatible with the channel measurement results of different terminals and inaccurate prediction is thereby caused.

In an embodiment, the terminal includes a first type of terminal and a second type of terminal, and the terminal capability of the first type of terminal is lower than the terminal capability of the second type of terminal.

The present disclosure may be applied to the cases of normal terminals and RedCap terminals to determine the terminal characteristics of different terminals. Thus, the channel measurement result is acquired based on the terminal characteristics of the terminal, and/or relevant processing is performed on the AI model. This can avoid the situation where the AI model is not compatible with the channel measurement results of different terminals and inaccurate prediction is thereby caused.

In an embodiment, the AI model corresponds to a category of terminal characteristics, and the AI model includes a first AI model corresponding to the terminal characteristics of the first type of terminal, and a second AI model corresponding to the terminal characteristics of the second type of terminal.

According to the present disclosure, different terminal characteristics correspond to the corresponding AI models respectively, so that the channel measurement result is used to perform relevant processing on the AI model corresponding to the terminal characteristics. This can avoid the situation where the AI model is not compatible with the channel measurement results of different terminals and inaccurate prediction is thereby caused.

In an embodiment, the communication apparatus 300 also includes a sending module 302. The sending module 302 is configured to: in response to the AI model being deployed on the terminal, send the AI model corresponding to the terminal characteristics of the terminal to the terminal.

The present disclosure may be applied to the situation where the AI model is deployed on the terminal, so that the channel measurement result is used to perform relevant processing on the AI model corresponding to the terminal characteristics. This can avoid the situation where the AI model is not compatible with the channel measurement results of different terminals and inaccurate prediction is thereby caused.

In an embodiment, the communication apparatus 300 further includes a receiving module 303. The receiving module 303 is configured to receive the channel measurement result sent by the terminal in response to the AI model being deployed on the network device.

The present disclosure may be applied to the situation where the AI model is deployed on the network device, so as to use the channel measurement result to perform relevant processing on the AI model corresponding to the terminal characteristics. This can avoid the situation where the AI model is not compatible with the channel measurement results of different terminals and the prediction is thereby inaccurate.

In an embodiment, the processing module 301 is also configured to: acquire the channel measurement result of the terminal for training, where the channel measurement result of the terminal for training includes the first model training data. The AI model is pre-trained in the following ways: acquiring the first model training data, where the first model training data includes the terminal characteristic parameters, and the terminal characteristic parameters are used to describe the terminal characteristics; using the first model training data with the same terminal characteristic parameters to train the AI initial model to obtain the AI model corresponding to the terminal characteristic parameters, where the AI initial model is an untrained AI model.

According to the present disclosure, an AI model is trained separately for each terminal characteristic, so as to use the channel measurement result to perform relevant processing on the AI model corresponding to the terminal characteristic. This can avoid the situation where the AI model is not compatible with the channel measurement results of different terminals and the prediction is thereby inaccurate.

In an embodiment, the AI model corresponds to multiple categories of terminal characteristics, and the AI model includes a third AI model. The third AI model corresponds to the terminal characteristics of the first type of terminal, and the third AI model further corresponds to the terminal characteristics of the second type of terminal.

According to the present disclosure, the same AI model may correspond to different terminal characteristics, so that the AI model corresponding to the terminal characteristics can be processed by using the channel measurement result. This can avoid the situation where the AI model is not compatible with the channel measurement results of different terminals and the prediction is thereby inaccurate.

In an embodiment, the sending module 302 is also configured to: in response to the AI model being deployed on the terminal, send the third AI model to the terminal.

The present disclosure may be applicable to the situation where the AI model is deployed on the terminal, so that the AI model corresponding to the terminal characteristics can be processed by using the channel measurement result. This can avoid the situation where the AI model is not compatible with the channel measurement results of different terminals and the prediction is thereby inaccurate.

In an embodiment, in response to the AI model being deployed on the network device, the receiving module 303 is also configured to: receive the corrected channel measurement result sent by the terminal in response to the terminal being the first type of terminal; or, the receiving module 303 is also configured to receive the channel measurement result sent by the terminal in response to the terminal being the first type of terminal. The processing module 301 is also configured to correct the channel measurement result to obtain the corrected channel measurement result. The processing module 301 is also configured to use the corrected channel measurement result to perform processing on the AI model.

According to the present disclosure, the channel measurement result measured by some terminals may be corrected, and the corrected channel measurement result is used to perform relevant processing on the AI model corresponding to the terminal characteristics. This can avoid the situation where the AI model is incompatible with the channel measurement results of different terminals and inaccurate prediction is thereby caused.

In an embodiment, in response to the AI model being deployed on the network device, the receiving module 303 is also configured to receive the channel measurement result sent by the terminal in response to the terminal being the second type of terminal; the processing module 301 is also configured to use the channel measurement result to perform processing on the AI model.

For some terminals, according to the present disclosure, the channel measurement result may be directly used to perform relevant processing on the AI model corresponding to the terminal characteristics. This can avoid the situation where the AI model is incompatible with the channel measurement results of different terminals and the prediction is thereby inaccurate.

In an embodiment, the processing module 301 is also configured to: acquire the channel measurement result of the terminal for training, where the channel measurement result of the terminal for training includes the second model training data. The AI model is pre-trained in the following ways: acquiring the second model training data, where the second model training data includes terminal characteristic parameters, and the terminal characteristic parameters are used to describe the terminal characteristics; correcting the first part of training data in the second model training data to obtain the corrected first part of training data, where the terminal characteristics described by the terminal characteristic parameters of the first part of training data correspond to the first type of terminal; using the corrected first part of training data and the second part of training data to train the AI initial model to obtain a third AI model. The terminal characteristics described by the terminal characteristic parameters of the second part of training data correspond to the second type of terminal. The AI initial model is an untrained AI model.

According to the present disclosure, the same AI model may be trained for different terminal characteristics, so as to use the channel measurement result to perform relevant processing on the AI model corresponding to the terminal characteristics. This can avoid the situation where the AI model is incompatible with the channel measurement results of different terminals and the prediction is thereby inaccurate.

In an embodiment, the terminal characteristics include: the terminal type and/or the terminal capability.

The present disclosure provides a variety of terminal characteristics so that the AI model adapted to the terminal characteristics can be used to perform relevant operations by using the channel measurement result. This can avoid the situation where the AI model is incompatible with the channel measurement results of different terminals and the prediction is thereby inaccurate.

Regarding the apparatus in the above embodiment(s), the specific manner in which each module performs the operation has been described in detail in the method embodiments, and will not be explained in detail here.

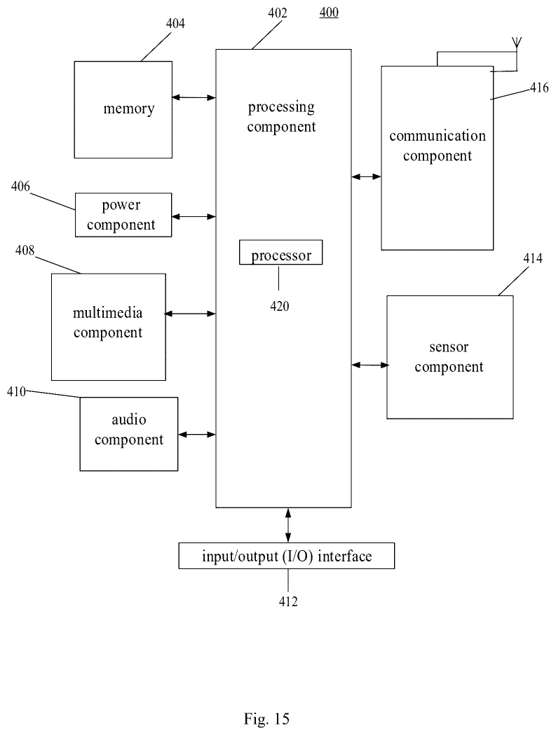

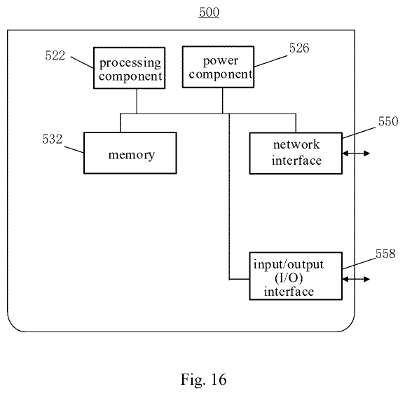

FIG. 15 is a schematic diagram of a communication device according to an example embodiment. For example, the communication device 400 may be any terminal such as a mobile phone, a computer, a digital broadcast terminal, a messaging device, a game console, a tablet device, a medical device, a fitness device, a personal digital assistant, etc.

Referring to FIG. 15, the communication device 400 may include one or more of the following components: a processing component 402, a memory 404, a power component 406, a multimedia component 408, an audio component 410, an input/output (I/O) interface 412, a sensor component 414, and a communication component 416.

The processing component 402 generally controls the overall operation of the communication device 400, such as operations associated with display, phone calls, data communications, camera operations, and recording operations. The processing component 402 may include one or more processors 420 to execute instructions to complete all or some of the steps of the above-mentioned method(s). In addition, the processing component 402 may include one or more modules to facilitate the interaction between the processing component 402 and other components. For example, the processing component 402 may include a multimedia module to facilitate the interaction between the multimedia component 408 and the processing component 402.

The memory 404 is configured to store various types of data to support the operation of the communication device 400. Examples of such data include instructions for any application or method operating on the communication device 400, contact data, phone book data, messages, pictures, videos, etc. The memory 404 may be implemented by any type of volatile or nonvolatile memory device or a combination thereof, such as Static Random Access Memory (SRAM), Electrically Erasable Programmable Read-Only Memory (EEPROM), Erasable Programmable Read-Only Memory (EPROM), Programmable Read-Only Memory (PROM), Read-Only Memory (ROM), magnetic memory, flash memory, magnetic disk, or optical disk.

The power component 406 provides power to various components of the communication device 400. The power component 406 may include a power management system, one or more power supplies, and other components associated with generating, managing, and distributing power for the communication device 400.

The multimedia component 408 includes a screen that provides an output interface between the communication device 400 and the user. In some embodiments, the screen may include a Liquid Crystal Display (LCD) and a Touch Panel (TP). If the screen includes a touch panel, the screen may be implemented as a touch screen to receive input signals from the user. The touch panel includes one or more touch sensors to sense touch, slide, and gestures on the touch panel. The touch sensor may not only sense the boundaries of the touch or slide action, but also detect the duration and pressure associated with the touch or slide operation. In some embodiments, the multimedia component 408 includes a front camera and/or a rear camera. When the communication device 400 is in an operating mode, such as a shooting mode or a video mode, the front camera and/or the rear camera may receive external multimedia data. Each of the front camera and the rear camera may be a fixed optical lens system or have a focal length and optical zooming capability.

The audio component 410 is configured to output and/or input audio signals. For example, the audio component 410 includes a microphone (MIC). The microphone (MIC) is configured to receive external audio signals when the communication device 400 is in an operating mode, such as a call mode, a recording mode, and a voice recognition mode. The received audio signal may be further stored in the memory 404 or sent via the communication component 416. In some embodiments, the audio component 410 also includes a speaker for outputting audio signals.

The I/O interface 412 provides an interface between the processing component 402 and the peripheral interface module, which may be a keyboard, a click wheel, a button, etc. These buttons may include, but are not limited to: a home button, a volume button, a start button, and a lock button.

The sensor component 414 includes one or more sensors for providing various aspects of status evaluation for the communication device 400. For example, the sensor component 414 may detect the on/off state of the communication device 400, the relative positioning of the components, such as the display and the keypad of the communication device 400. The sensor component 414 may also detect the position change of the communication device 400 or a component of the communication device 400, the presence or absence of contact between the user and the communication device 400, the orientation or acceleration/deceleration of the communication device 400, and the temperature change of the communication device 400. The sensor component 414 may include a proximity sensor, which is configured to detect the presence of a nearby object without any physical contact. The sensor component 414 may also include a light sensor, such as a CMOS or CCD image sensor, for use in imaging applications. In some embodiments, the sensor component 414 may also include an accelerometer, a gyroscope, a magnetic sensor, a pressure sensor, or a temperature sensor.

The communication component 416 is configured to facilitate wired or wireless communication between the communication device 400 and other devices. The communication device 400 may access a wireless network based on a communication standard, such as WiFi, 2G or 3G, or a combination thereof. In an example embodiment, the communication component 416 receives a broadcast signal or broadcast-related information from an external broadcast management system via a broadcast channel. In an example embodiment, the communication component 416 also includes a Near Field Communication (NFC) module to facilitate short-range communication. For example, the NFC module may be implemented based on Radio Frequency Identification (RFID) technology, Infrared Data Association (IrDA) technology, Wltra-WideBand (UWB) technology, Bluetooth (BT) technology, and other technologies.

In an example embodiment, the communication device 400 may be implemented by one or more Application-Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, microcontrollers, microprocessors, or other electronic components to perform the above method(s).

In an example embodiment, a non-transitory computer-readable storage medium including instructions is also provided, such as a memory 404 including instructions. The above instructions may be executed by a processor 420 of the communication device 400 to complete the above method(s). For example, the non-transitory computer-readable storage medium may be a ROM, a Random Access Memory (RAM), a CD-ROM, a tape, a floppy disk, and an optical data storage device, etc.

FIG. 16 is a schematic diagram of another communication device according to an example embodiment. For example, the communication device 500 may be provided as a base station, or a server. Referring to FIG. 16, the communication device 500 includes a processing component 522, which further includes one or more processors, and a memory resource represented by a memory 532 for storing instructions executable by the processing component 522, such as an application. The application stored in the memory 532 may include one or more modules each corresponding to a set of instructions. In addition, the processing component 522 is configured to execute instructions to perform the above method(s).

The communication device 500 may also include: a power component 526 configured to perform power management of the communication device 500; a wired or wireless network interface 550 configured to connect the communication device 500 to the network; and an input/output (I/O) interface 558. The communication device 500 may operate based on an operation system stored in the memory 532, such as Windows Server™, Mac OS X™, Unix™, Linux™, FreeBSD™ or the like.

The present disclosure determines the terminal characteristics of the terminal so that the channel measurement result is processed accordingly based on the terminal characteristics, and/or relevant operations are performed on the AI model. This can avoid the situation where the AI model is incompatible with the channel measurement results of different terminals and inaccurate prediction is thereby caused.

It can be further understood that in the present disclosure, “a plurality of” refers to two or more, and other quantifiers are similar. “And/or” describes the association relationship of the associated objects, indicating that there may be three relationships. For example, A and/or B may represent: A exists alone; A and B exist at the same time; and B exists alone. The character “/” generally indicates that the objects associated with each other are in an “or” relationship. The singular forms “a”, “the”, and “said” are also intended to include the plural forms, unless the context clearly indicates otherwise.

It is further understood that the terms “first”, “second”, etc. are used to describe various information, but these information should not be limited to these terms. These terms are only used to distinguish the same type of information from each other and do not indicate a specific order or degree of importance. In fact, the expressions “first”, “second”, etc. may be used interchangeably. For example, without departing from the scope of the present disclosure, the first information may also be referred to as the second information, and similarly, the second information may also be referred to as the first information.

It is further understood that the meaning of the words “in response to” and “if” involved in the present disclosure depends on the context and the actual use scenario. For example, the word “in response to” used herein may be interpreted as “at” or “when” or “if” or “in case”.

It is further understood that although the operations are described in a specific order in the drawings in the embodiments of the present disclosure, this should not be understood as requiring the operations to be performed in the specific order as shown or in a serial order, or requiring the execution of all the operations shown to obtain the desired results. In certain environments, multitasking and parallel processing may be advantageous.

Other embodiments of the present disclosure will be readily apparent to those skilled in the art after considering the specification and practicing the content disclosed herein. The present application is intended to cover any variation, use, or adaptation of the present disclosure that follows the general principles of the present disclosure and includes common knowledge or conventional techniques in the art that are not disclosed in the present disclosure.

It should be understood that the present disclosure is not limited to the precise structures described above and shown in the accompanying drawings, and that various modifications and changes may be made without departing from the scope thereof. The scope of the present disclosure is limited only by the scope of the appended claims.

1. A communication method, performed by a terminal and comprising at least one of:
acquiring a channel measurement result of the terminal based on terminal characteristics of the terminal, or
using the channel measurement result to perform processing on an Artificial Intelligence (AI) model.

2. The method according to claim 1, wherein
the terminal comprises a first type of terminal and a second type of terminal, and
a terminal capability of the first type of terminal is lower than a terminal capability of the second type of terminal.

3. The method according to claim 2, wherein
the AI model corresponds to a category of terminal characteristics, and
the AI model comprises a first AI model corresponding to the terminal characteristics of the first type of terminal, and a second AI model corresponding to the terminal characteristics of the second type of terminal.

4. The method according to claim 3, further comprising:
in response to the AI model being deployed on the terminal, receiving the AI model corresponding to the terminal characteristics of the terminal and sent by the network device; or
in response to the AI model being deployed on a network device, sending the channel measurement result to the network device.

5. (canceled)

6. The method according to claim 3, wherein the AI model is pre-trained by:
acquiring first model training data, wherein the first model training data comprises terminal characteristic parameters, and the terminal characteristic parameters are used to describe the terminal characteristics;
using the first model training data with the same terminal characteristic parameters to train an AI initial model to obtain the AI model corresponding to the terminal characteristic parameters, wherein the AI initial model is an untrained AI model.

7. The method according to claim 2, wherein
the AI model corresponds to a plurality of categories of terminal characteristics, the AI model comprises a third AI model, the third AI model corresponds to the terminal characteristics of the first type of terminal, and the third AI model further corresponds to the terminal characteristics of the second type of terminal.

8. The method according to claim 7, further comprising:
in response to the AI model being deployed on the terminal, receiving the third AI model sent by a network device.

9. The method according to claim 8,
wherein using the channel measurement result to perform processing on the Artificial Intelligence (AI) model comprises:
in response to the terminal being the first type of terminal, correcting the channel measurement result;
using the corrected channel measurement result to perform processing on the AI model, or
wherein using the channel measurement result to perform processing on the Artificial Intelligence (AI) model comprises:
in response to the terminal being the second type of terminal, using the channel measurement result to perform processing on the AI model.

10. (canceled)

11. The method according to claim 7, wherein in response to the AI model being deployed on a network device, acquiring the channel measurement result of the terminal for processing comprises:
in response to the terminal being the first type of terminal, correcting the channel measurement result, and sending the corrected channel measurement result to the network device; or
in response to the terminal being the first type of terminal, sending the channel measurement result to the network device; or
in response to the terminal being the second type of terminal, sending the channel measurement result to the network device.

12. (canceled)

13. The method according claim 7, wherein the AI model is pre-trained by:
acquiring second model training data, wherein the second model training data comprises terminal characteristic parameters, and the terminal characteristic parameters are used to describe the terminal characteristics;
correcting a first part of training data in the second model training data to obtain the corrected first part of training data, wherein the terminal characteristics described by the terminal characteristic parameters of the first part of training data correspond to the first type of terminal;
using the corrected first part of training data and a second part of training data to train an AI initial model to obtain the third AI model, wherein the terminal characteristics described by the terminal characteristic parameters of the second part of training data correspond to the second type of terminal, and the AI initial model is an untrained AI model.

14. (canceled)

15. A communication method, performed by a network device and comprising at least one of:
acquiring a channel measurement result of a terminal based on terminal characteristics of the terminal, or
using the channel measurement result to perform processing on an Artificial Intelligence (AI) model.

16. The method according to claim 15, wherein
the terminal comprises a first type of terminal and a second type of terminal, and
a terminal capability of the first type of terminal is lower than a terminal capability of the second type of terminal.

17. The method according to claim 16, wherein
the AI model corresponds to a category of terminal characteristics, and
the AI model comprises a first AI model corresponding to the terminal characteristics of the first type of terminal, and a second AI model corresponding to the terminal characteristics of the second type of terminal.

18. The method according to claim 17,
wherein the method further comprising:
in response to the AI model being deployed on the terminal, sending the AI model corresponding to the terminal characteristics of the terminal to the terminal, or
wherein acquiring the channel measurement result of the terminal comprises:
in response to the AI model being deployed on a network device, receiving the channel measurement result sent by the terminal.

19. (canceled)

20. The method according to claim 17,
wherein acquiring the channel measurement result of the terminal comprises:
acquiring the channel measurement result of the terminal for training, wherein the channel measurement result of the terminal for training comprises first model training data,
wherein the AI model is pre-trained by:
acquiring the first model training data, wherein the first model training data comprises terminal characteristic parameters, and the terminal characteristic parameters are used to describe the terminal characteristics;
using the first model training data with the same terminal characteristic parameters to train an AI initial model to obtain the AI model corresponding to the terminal characteristic parameters, wherein the AI initial model is an untrained AI model.

21. The method according to claim 16, wherein
the AI model corresponds to a plurality of categories of terminal characteristics, the AI model comprises a third AI model, the third AI model corresponds to the terminal characteristics of the first type of terminal, and the third AI model further corresponds to the terminal characteristics of the second type of terminal.

22. (canceled)

23. The method according to claim 21,
wherein the method further comprises:
in response to the AI model being deployed on the terminal, sending the third AI model to the terminal, or
wherein in response to the AI model being deployed on the network device, acquiring the channel measurement result of the terminal comprises:
in response to the terminal being the second type of terminal, receiving the channel measurement result sent by the terminal; or
in response to the terminal being the first type of terminal, receiving the corrected channel measurement result sent by the terminal; or
in response to the terminal being the first type of terminal, receiving the channel measurement result sent by the terminal, and correcting the channel measurement result to obtain the corrected channel measurement result,
wherein using the channel measurement result to perform processing on the Artificial Intelligence (AI) model comprises:
using the channel measurement result or the corrected channel measurement result to perform processing on the AI model.

24. (canceled)

25. The method according claim 21,
wherein acquiring the channel measurement result of the terminal comprises:
acquiring the channel measurement result of the terminal for training, wherein the channel measurement result of the terminal for training comprises second model training data,
wherein the AI model is pre-trained by:
acquiring the second model training data, wherein the second model training data comprises terminal characteristic parameters, and the terminal characteristic parameters are used to describe the terminal characteristics;
correcting a first part of training data in the second model training data to obtain the corrected first part of training data, wherein the terminal characteristics described by the terminal characteristic parameters of the first part of training data correspond to the first type of terminal;
using the corrected first part of training data and a second part of training data to train an AI initial model to obtain the third AI model, wherein the terminal characteristics described by the terminal characteristic parameters of the second part of training data correspond to the second type of terminal, and the AI initial model is an untrained AI model.

26-28. (canceled)

29. A communication device, comprising:
a processor; and
a memory for storing instructions executable by the processor,
wherein the processor is configured to perform a communication method, comprising at least one of:
acquiring a channel measurement result of the terminal based on terminal characteristics of the terminal, or
using the channel measurement result to perform processing on an Artificial Intelligence (AI) model.

30. A communication device, comprising:
a processor; and
a memory for storing instructions executable by the processor,
wherein the processor is configured to perform the method according to claim 15.

31.-32. (canceled)
